(19) United States
(12) Patent Application Publication
(10) Pub. No.: US 2015/0103698 A1
(43) Pub. Date: Apr. 16, 2015

(54) SYSTEM AND METHOD FOR TOPOLOGY OPTIMIZATION WITH A PLURALITY OF MATERIALS

(71) Applicant: GM GLOBAL TECHNOLOGY OPERATIONS LLC, Detroit, MI (US)

(72) Inventors: RAJAN R. CHAKRAVARTY, TROY, MI (US); WEIZHANG SIMON XU, TROY, MI (US); KRISTEL E. CORONADO, COMMERCE TOWNSHIP, MI (US)

(73) Assignee: GM GLOBAL TECHNOLOGY OPERATIONS LLC, Detroit, MI (US)

(21) Appl. No.: 14/051,097

(22) Filed: Oct. 10, 2013

(51) Int. Cl. H04L 12/751

(52) U.S. Cl. CPC H04L 45/02
USPC 370/255

(57) ABSTRACT

A method for producing a design topology is provided. The method includes entering a problem constraint into a computer, wherein the problem constraint includes a domain, a load vector, an objective function, and a plurality of types of materials. The domain is divided into a plurality of elements, wherein individual elements are associated with one type of material such that each of the plurality of types of materials is associated with more than one element. A element variable is calculated for the element, and the computer determines if the calculations are complete. If the calculations are not complete, the step of calculating the element variable for the elements is repeated. If the calculations are complete, the design topology is output.

### TECHNICAL FIELD

The technical field relates to a system and method of producing a domain topology, and more particularly relates to a system and method of optimizing a domain topology using finite element analysis and a plurality of types of materials.

### BACKGROUND

Structures are designed for a wide variety of purposes, and the required performance criterion varies widely depending on the intended use and purpose of the structure. For example, weight is generally a more important criterion for components in an airplane than for a bridge. Analytical methods are available to create mathematical models, or topologies, for certain shapes, such as an “I” beam where known equations produce accurate models for how the structure will behave under identified loads. However, these analytical methods are not easily applied to many complex shapes. In recent years, finite element analysis has been used with partial differential equations to help design topologies for complex shapes. Finite element analysis is a mathematical approach that breaks a domain or area into a plurality of finite elements, and calculates how applied loads will affect each element or node.

Finite element analysis is used as a preliminary design tool at the concept stage. A general domain can be analyzed under an applied load, and the results can aid in the design of a structure. Many factors other than the finite element analysis are used to determine the final shape of the structure, such as manufacturability, aesthetics, cost, etc., so the topology from the finite element analysis is one tool used to aid in designing a structure. As it is often more economical to model a potential structural shape to approximate performance than to manufacture and test prototypes, finite element analysis is gaining in popularity. A wide variety of stresses can be analyzed, such as strain energy, stress, mass, volume, temperature, displacement, velocity, acceleration, etc.

In some embodiments, an initial domain is established and divided into a plurality of finite elements. A finite element analysis calculates strain energy from a given load vector to create a topology by identifying whether a predefined type of material should be present or absent from each element. However, existing commercially available programs for optimizing the topology are limited to a single type of material. As many products and structures use more than one type of material, the finite element analysis for each type of material must be analyzed separately. This limits the ability to determine an optimum design topology that incorporates the different properties of more than one type of material.

Accordingly, it is desirable to provide systems and methods for producing a design topology for a plurality of types of materials. In addition, it is desirable to provide systems and methods for simultaneously optimizing the design topology for a plurality of types of materials. Furthermore, other desirable features and characteristics of the present embodiment will become apparent from the subsequent detailed description and the appended claims, taken in conjunction with the accompanying drawings and this background of the invention.

### SUMMARY

A method is provided for producing a design topology. The method includes entering a problem constraint into a computer, wherein the problem constraint includes a domain, a load vector, an objective function, and a plurality of types of materials. The domain is divided into a plurality of elements, wherein individual elements are associated with one type of material such that each of the plurality of types of materials is associated with more than one element. A element variable is calculated for the element, and the computer determines if the calculations are complete. If the calculations are not complete, the step of calculating the element variable for the elements is repeated. If the calculations are complete, the design topology is output.

In accordance with another embodiment, a system is provided for producing a design topology. The system includes a computer with non-transitory computer readable media, an input device, and an output device. The computer is configured to accept entry of a problem constraint from the input device, wherein the problem constraint includes a domain, a load vector, an objective function, and a plurality of types of materials. The computer is also configured to divide the domain into a plurality of elements, where individual elements are associated with one type of material such that each of the plurality of types of materials is associated with more than one element. The computer iteratively calculates a element variable for the elements until the calculations are complete, and then the computer outputs the design topology.

### DESCRIPTION OF THE DRAWINGS

The exemplary embodiments will hereinafter be described in conjunction with the following drawing figures, wherein like numerals denote like elements, and wherein:

FIG. 1 is a block diagram representing an exemplary embodiment of a computer;

FIG. 2 is a block diagram representing an exemplary embodiment of the problem constraint;

FIG. 3 illustrates an exemplary embodiment of a motor vehicle with a load vector applied to the wheels;

FIG. 4 is a flow chart of an exemplary embodiment of a method for topological optimization;

FIG. 5 is a diagram of an exemplary embodiment of a domain;

FIG. 6 is a diagram of another exemplary embodiment of a domain;

FIG. 7 is a diagram of an exemplary embodiment of a design topology based on the domain from FIG. 5; and

FIG. 8 illustrates an exemplary embodiment of a structure based on the design topology from FIG. 7.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Preliminary designs are mathematically modeled to assist designers in determining a final structure that will be used. Finite element analysis uses known equations to create a topology, or mathematical model, of a structure. The topology optimizes selected variables, such as strain energy, and can do so while controlling other variables within prescribed limits, such as total mass. The finite element analysis begins with a domain, which is an area or volume that encompasses the final structure, and a plurality of different types of materials. The domain is divided into a plurality of elements, and individual elements are associated with one of the types of materials being analyzed. Therefore, elements associated with one of the types of materials fills part of the domain, and elements associated with the other types of materials fill the rest of the domain. The selected variables are iteratively calculated for each element, and the results are gradually forced to represent either a full element or a void element. The iterative calculations are continued until the topology is complete, and then the topology is output. The topology illustrates locations within the domain where each of the plurality of types of materials are located to provide the optimum performance for the selected variables. The topology is then used as a design aid for the final structure.

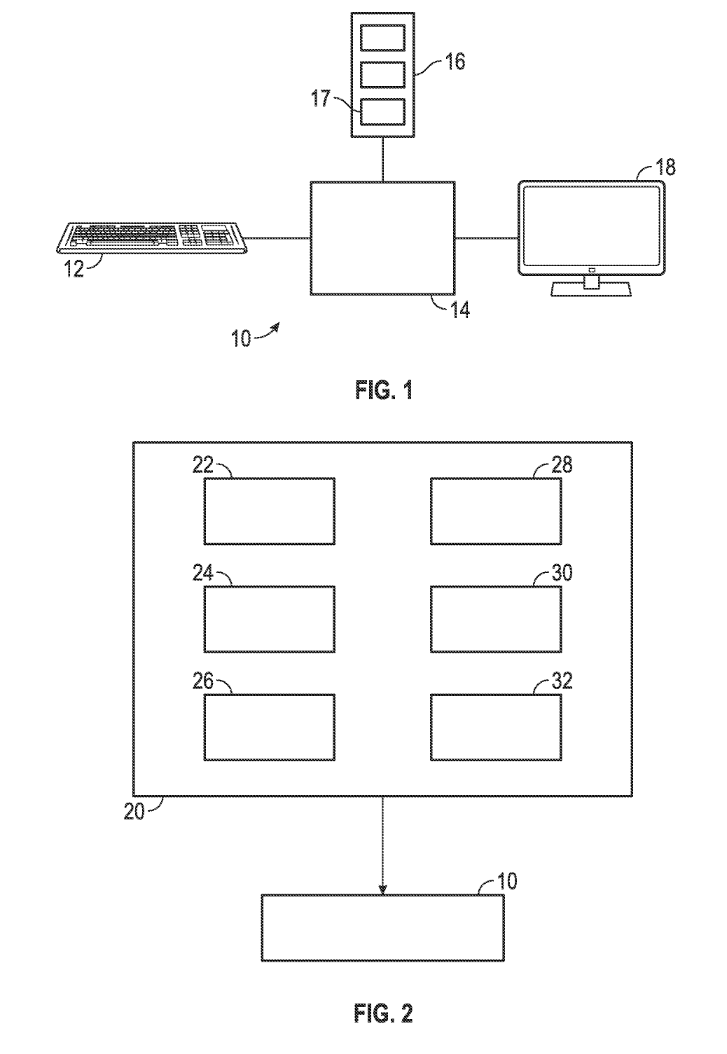

Referring now to FIG. 1, the finite element analysis is performed by a computer 10. In an exemplary embodiment, the finite element analysis involves individual calculations for many different locations, and the calculations are repeated iteratively using the results from the prior iteration. A vast number of calculations are performed, so a computer is required to complete the analysis in a timely manner. The computer 10 includes an input device 12, such as a keyboard, a modem, a touch screen, or a “mouse”, and the input device 12 is configured to enter information or data to a processor 14. The input can be manually entered, downloaded from a network, or otherwise provided to the computer 10 using the input device 12. The computer 10 also includes a non-transitory computer readable medium 16 for saving and accessing information and programs. The non-transitory computer readable medium 16 is a tangible device, such as a hard disc, a floppy disc, a USB flash drive, etc. The non-transitory computer readable medium 16 includes a program accessed by the processor 14 to implement the finite element analysis based on data entered by the input device 12. The non-transitory computer readable medium 16 also includes a database 17 in some embodiments, where the database 17 stores and provides access to information used in the finite element analysis. The computer 10 also includes an output device 18 for outputting results. The output device 18 includes, but is not limited to, a modem, a printer, a monitor, a display, or other devices capable of accepting an output from the computer 10.

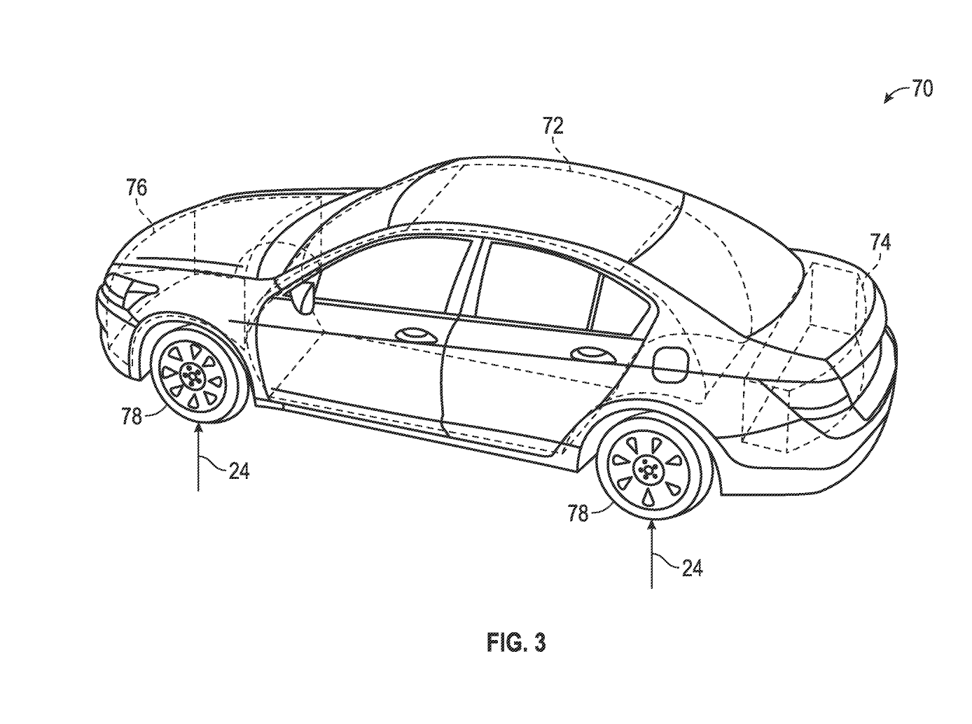

Referring now to an exemplary embodiment illustrated in FIGS. 2 and 3, with continuing reference to FIG. 1, the process for producing a calculated design topology begins with entering a problem constraint 20, where the problem constraint 20 includes the specific details that set up an individual analysis to be performed. For example, the problem constraint 20 includes the area to analyze and the loads placed on that area, so the data entered in the problem constraint 20 changes for different structures or different forces placed on the structure. A domain 22 is entered, where the domain 22 is an area (for a 2 dimensional analysis) or volume (for a 3 dimensional analysis) that encompasses the final structure that will be produced. The domain 22 is typically established by a geographic coordinate system. The domain 22 can be a solid block, in which case a wide variety of design topologies are possible, but in many embodiments the domain 22 is restricted based on preliminary design criteria. For example, if the structure to be evaluated is a motor vehicle 70 or a portion of a motor vehicle 70, the general shape and contours of the domain 22 are limited and established by the type and size of the motor vehicle 70. If the motor vehicle 70 is a van, the beginning domain 22 is quite different than if the motor vehicle 70 is a truck, and the domain 22 entered into the computer 10 is structured based on the general final structure desired. The domain 22 can be a two dimensional shape, such as if the domain 22 represents sheet metal, but the domain 22 can also be a three dimensional shape, such as the body of a motor vehicle 70. In some embodiments, there are cavities within the domain 22, such as for a motor vehicle passenger compartment 72, a trunk 74, and an engine compartment 76. The domain 22 is entered by geographically defining a domain boundary, or the edges or faces of the domain 22, and the domain boundary is typically defined using a coordinate system.

A load vector 24 is also entered in the problem constraint 20, where the load vector 24 has a magnitude and a direction. The load vector 24 is a force applied to the domain 22, and the force is applied at a specific location and in a specific direction. For example, if the domain 22 is a motor vehicle 70, the load vector 24 could be the force applied at the wheels 78 when the motor vehicle 70 drives over a speed bump. In this example, the load vector 24 would be located at four points, one for each wheel 78, and the direction of the force would be generally upward at the wheels 78. The magnitude could depend on the weight of the motor vehicle 70, the size of the speed bump, and the speed of the motor vehicle 70 at the time of impact. In general, a load vector is an external force applied to the system. In an alternate example, a passenger of the motor vehicle 70 weights 80 kilograms. That passenger can be represented as a load vector in the downward direction with a magnitude of 80 kilograms.

In some embodiments, a required performance criterion 26 is entered as part of the problem constraint 20. In the example of a motor vehicle 70 driving over a speed bump, the required performance criterion 26 could be the acceleration at the drivers seat must be less than a specified value. In an alternate exemplary embodiment, the required performance criterion 26 is to restrict the total mass of the domain 22 to be less than a specific value, thereby setting a maximum allowable total mass of the domain 22. The performance criterion 26 can vary for different problem constraints 20, and the number of performance criterion 26 can also vary.

A plurality of types of materials 28 are entered as part of the problem constraint 20. The types of materials 28 can be established for particular portions of the domain 22, and allowed to vary for other locations. In an exemplary embodiment of a motor vehicle 70 passing over a speed bump, the floor of the passenger compartment 72 is set as carbon steel, but the trunk 74, engine compartment 76, doors, roof, and supports are selected from either carbon steel or aluminum. In such a case, a portion of the domain 22 is set as a particular type of material 28, and other portions include a plurality of types of materials 28. In other embodiments, there are more than two types of materials 28, including, but not limited to, carbon steel, various polymers, aluminum, glass, wood, etc. The properties of the various types of materials 28 are entered or recalled from the database 17, so the material properties are incorporated into the calculations to determine the design topology.

An objective function 30 is entered as part of the problem in some embodiments, where the objective function 30 is optimized by the finite element analysis calculations. Returning to the exemplary embodiment of a motor vehicle 70 driving over a speed bump, the objective function 30 is minimum strain energy. The objective function 30 of minimum strain energy produces a design topology with the stiffest structure. When the objective function 30 of minimum strain energy is combined with the required performance criterion 26 of a constrained mass, the design topology obtained is the stiffest structure with the allocated mass. Other objective functions 30 could be used in other embodiments, such as minimum mass or minimum acceleration. Minimum accelerations are generally used to minimize a given response, such as displacement, velocity, acceleration, area, etc.

A fixed domain location 32 is entered as part of the problem constraint 20 in some embodiments. The fixed domain location 32 is a point or region of the domain 22 that does not move or change position during the iterative finite element analysis calculations. In the example of the motor vehicle 70 driving over a speed bump, the entire motor vehicle 70 moves, so there may not be a fixed domain location 32 in the problem constraint 20. However, from the reference point of the motor vehicle 70, the load vector 24 can be simulated by a force applied upwardly on the wheels 78 of a stationary motor vehicle 70. Therefore, the body of the motor vehicle 70 could be a fixed domain location 32, where the force on the wheels 78 is absorbed by a wheel suspension system that moves the wheels 78 relative to the body of the motor vehicle 70. In effect, some regions of the motor vehicle 70 can be fixed, so they do not move. In many embodiments, certain structures or areas of the domain 22 are fixed for a finite element analysis, but in some embodiments there are no fixed areas.

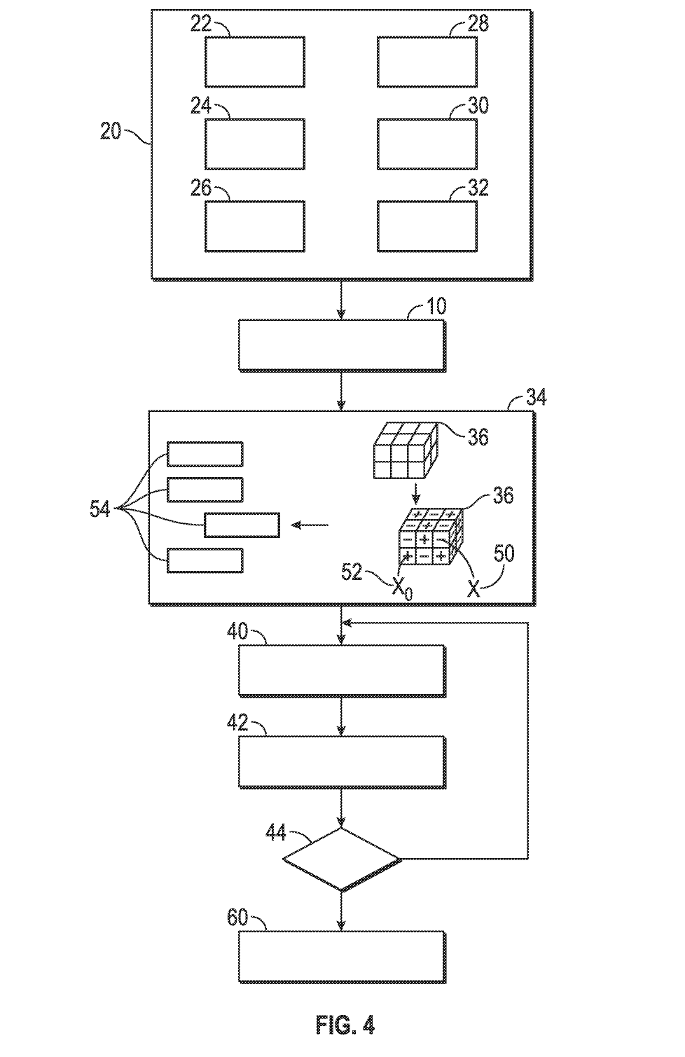

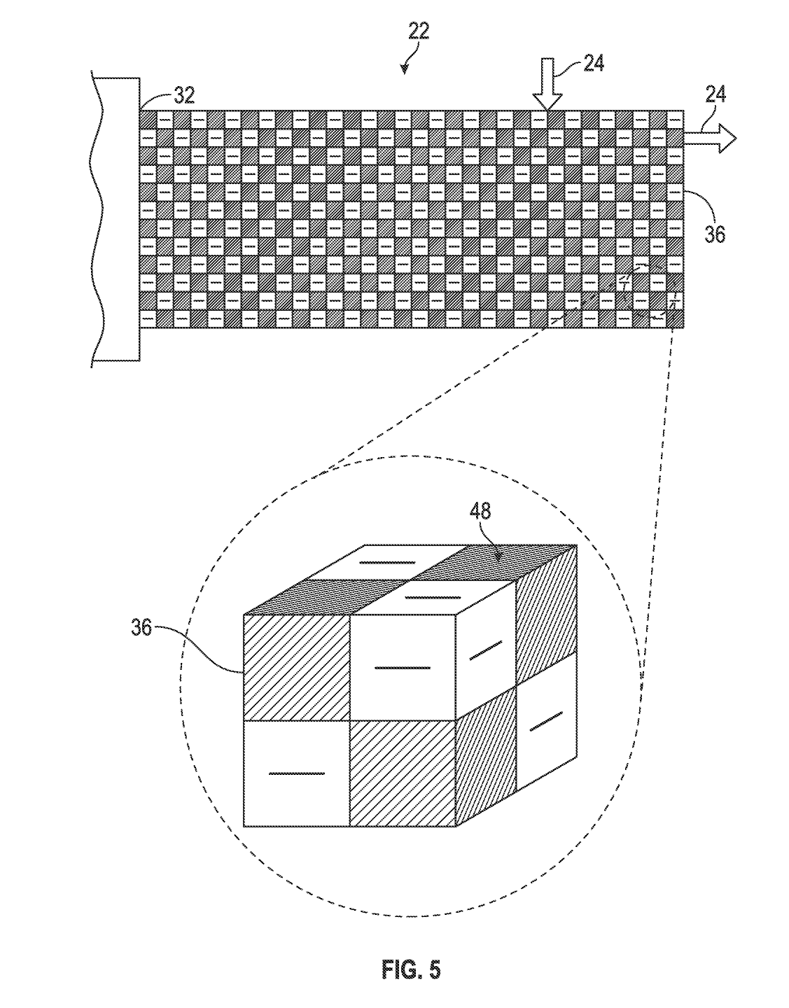

Referring now to the exemplary embodiment illustrated in FIGS. 4 and 5, a model 34 is developed once the problem constraint 20 is entered into the computer 10. The computer 10 is configured to develop the model 34 based on the data input for the problem constraint 20. In some embodiments, additional data is entered into computer 10 to guide the model 34. The entered domain 22 is divided into a plurality of elements 36, wherein the entire surface area of a 2 dimensional domain 22 is divided into 2 dimensional elements 36, and the entire volume of a 3 dimensional domain 22 is divided into 3 dimensional elements 36. Cavities within the domain 22, such as a passenger compartment, are not part of the domain 22 and therefore are not divided into elements 36. In some embodiments, the size or shape of the elements 36 is entered into the computer 10. However, in other embodiments, an algorithm uses pre-determined criteria to divide the domain 22 into elements 36. A larger number of elements 36 typically produce a more accurate model, whereas a smaller number of elements 36 requires less computer time for the analysis. The elements 36 for a 2 dimensional domain 22 are triangular or rectangular in many embodiments, and rectangular blocks or triangular pyramids are used in many embodiments for a 3 dimensional domain 22, but other shapes are used in alternate embodiments. It is also possible for the shape of the elements 36 to vary within the domain 22.

The elements 36 are associated with one of the types of materials 28, and each individual element 36 is associated with only one type of material 28. However, each of the types of materials 28 entered in the problem constraint 20 have some elements 36 associated with it. For each individual element 36, the finite element analysis calculations are limited to a single type of material 28. Therefore, each element 36 is associated with only one type of material 28, but the adjacent or nearby elements 36 are associated with different types of materials 28. In an exemplary embodiment with two types of materials 28, half of the elements 36 are associated with one of the types of material 28, and the other half of the elements 36 are associated with the other type of material 28. In an alternate embodiment with two types of materials 28, there are more elements 36 associated with one type of material 28 than the other, so more detail is provided for the type of material 28 with more elements 36. In alternate embodiments, three or more types of materials 28 are entered in the problem constraint 20.

Several different methods can be used to associate the elements 36 with the types of materials 28. In one embodiment, the domain 22 is completely traversed in a regular pattern, element 36 by element 36, and the types of materials 28 are randomly associated to the elements 36. In another embodiment, the domain 22 is completely traversed in a regular pattern, element 36 by element 36, and the types of materials 28 are associated with the elements 36 in a repeating order like a 2 dimensional or 3 dimensional checkerboard. A wide variety of regular patterns are possible, or alternatively no regular pattern is used to associate elements 36 with a type of material 28 in some embodiments. One exemplary embodiment numbers the elements 36 beginning with one and counting up by ones. Element 1 is the front bottom left element 36 of the domain 22, and element 2 is directly to the right of element 1. Element 3 is directly to the right of element 2, and so on until the left domain boundary is reached. The next element 36 is one row above the bottom row, at the front of the domain 22, and at the left domain boundary. The pattern is repeated until the entire front sheet of elements 36 is assigned a number, and then the process is repeated for the sheet of elements 36 second from the front of the domain boundary. The types of materials 28 are then numbered beginning with one and counting upward. Element 1 is then associated with material 1, and element 2 is associated with material 2. In embodiments with two materials 28, element 3 is then associated with material 1, and so on. There are many more elements 28 than types of materials 28, so the types of materials 28 are repeatedly associated in the same order until all the elements 36 are associated with one type of material 28. The random assignment is biased to favor one type of material 28 in some embodiments, as mentioned above, or a repeating pattern of the types of materials 28 is used, where the repeating pattern represents one type of material 28 more than another. The domain 22 is divided into sub-domains in some embodiments, and different methods are used to associate the elements 36 with the types of materials 28 for different sub-domains. This allows analysis of different types of materials 28 in different parts of the domain 22, or a different emphasis on the types of materials 28 in different parts of the domain 22. Either a systematic or random method is used to associate the elements 36 with the types of materials 28, such that a plurality of elements 36 are associated with each type of material 28, and elements 36 associated with each type of material 28 are spread throughout the domain 22.

The domain 22 in FIG. 5 is a side view of a 3 dimensional shape representing an beam, with an enlarged perspective view of eight of the elements 36. The domain 22 is divided in alternating elements 36 associated with the two different types of materials 28 in a checkerboard pattern, where one type of material 28 is indicated with a shaded element 36 and another type of material is indicated with a dash in the element 36. In this example, the elements 36 are 3 dimensional cubes, and the elements 36 have element faces 48. For a cubical or rectangular block-shaped element, 36 there are 6 element faces 48. The element faces 48 of the elements 36 associated with one type of material abut either (i) a element face 48 for the elements 36 associated with a different type of material 28, or (ii) the domain boundary. The domain boundary is the side or end of the domain 22, as mentioned above, so the element faces 48 at the domain boundary do not abut any elements 36. For example, in the enlarged section illustrated in FIG. 5, a shaded element 36 is associated with one material 22, and the adjacent element, which is illustrated with a dash instead of shading, is associated with a different material. As can be seen, the element faces of the shaded element abut either (i) an element face of an element with a dash, or (ii) a domain boundary, but they do not abut an element face of another shaded element.

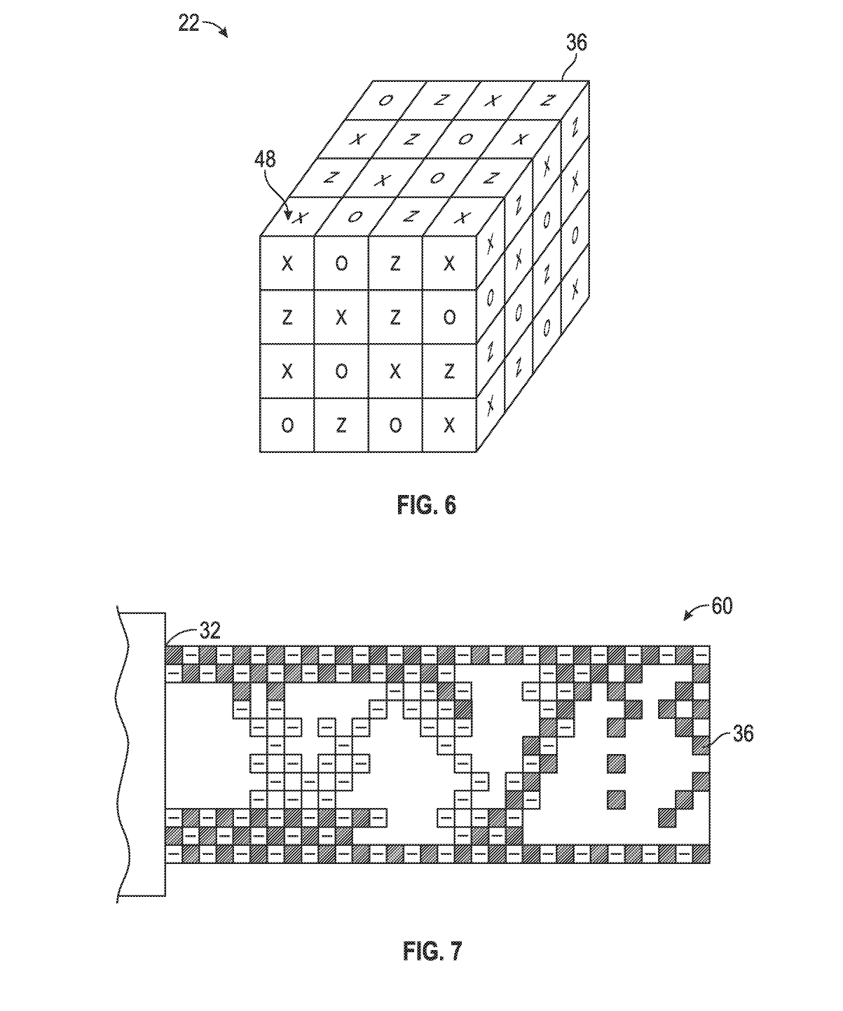

Reference is now made to FIGS. 4-6. In FIG. 5, the elements 36 associated with one type of material 28 are all connected at the corners and along one edge so the checkerboard patterned domain 22 can be traversed by connected elements 36 associated with one single type of material 28. The domain 22 is divided into elements 36 in a structured manner when the domain 22 can be traversed by connected elements 36 associated with a single type of material 28. In some embodiments, the domain 22 is divided into elements 36 in an unstructured manner, such as illustrated in FIG. 6, where 3 types of materials (X, O, and Z) are analyzed. In alternate embodiments, the elements 36 may have shapes other than cubical for 3 dimensional domains 22 (such as tetrahedral, pentahedral, etc), or other than square for 2 dimensional domains 22. Unstructured division of the domain 22 is typically used for more than two types of materials 28, domains 22 with convoluted shapes or where a structured division is otherwise not possible, or analysis where more emphasis is placed one type of material 28 than another. The structured division of elements 36 generally provides more representative results than the unstructured division of elements 36.

The finite element analysis solves for a element variable 50, and the nature of the element variable 50 depends on what information is sought. In one embodiment, the element variable 50 is the mass fraction of the element 36. The model 34 establishes a baseline element value 52 for the element variable 50 for use in the first iteration of the finite element analysis calculations. The same baseline element value 52 is used for all of the elements 36 associated with one type of material 28, but elements 36 associated with different types of materials 28 could have different baseline element values 52. However, in some embodiment the baseline element value 52 is the same for all the elements 36. In some embodiments, the baseline element value 52 is established so the total mass of the domain 22 is at or below the maximum allowable total mass provided as a required performance criterion 26.

An equation 54 or set of equations 54 are selected for use in the model 34 based on the type of information desired and the information provided in the problem constraint 20. The equations 54 used in the finite element analysis are well known to those of skill in the art. In one embodiment, the equations 54 are selected to determine a minimum strain energy for the domain 22 while remaining within required performance criteria 26, and the finite element analysis returns a mass fraction as the element variable 50 for each element 36. For example, the Genesis Design Manual, version 12.2, by Vanderplaats Research and Development, Inc., describes the topology governing equations 54 listed below:

E=Eₘᵢₙ+(E₀−Eₘᵢₙ)(X^{RV1}) and; Equation 1:

ρ=ρ₀(X) Equation 2:

where E is the current elasticity of the element 36 at some mass fraction, Eₘᵢₙ is the elasticity of a void element 36, E₀ is the elasticity of a full element 36, X is the mass fraction (and the element variable 50), RV1 is a constant (such as 3), ρ is the current density of the element 36, and ρₒ is the density of the type of material 28 associated with the element 36. The elasticity of a void element, Eₘᵢₙ, is defined by Eₘᵢₙ=E₀(RV2), where RV2 is a small constant, such as 10⁻⁶. RV2 is set as a small constant to represent a void element 36, so the value of E₀ is negligible in the calculations. RV2 is not set at zero because some of the equations 54 require a non-zero value for Eₘᵢₙ, so a predetermined value for Eₘᵢₙ is established and used to define a element 36 as void. The selected value for Eₘᵢₙ that represents a void element 36 is negligible in the calculations, which in some embodiments is a value of 1/1000 or less then the value of a full element 36. The mass fraction, X, varies between 0 and 1, where 0 represents a void element, and 1 represents a full element. When X=0, the elasticity is Eₘᵢₙ, which is defined as the elasticity of a void element. Many other equations 54 are known and used in alternate embodiments, as is well known to those skilled in the art.

Other equations 54 are also selected and used as appropriate, such as to approximate the strain energy or stress. For example, the strain energy in a bar under an axial load is given by equation 3:

U=P²L/2EA, Equation 3:

where U is elastic strain energy, P is the force, L is the initial length of the bar, E is the Young's modulus for the type of material 28 of the bar, and A is the cross sectional area of the bar. Equation 3 can be integrated and solved for specific locations within the bar, as is understood by those skilled in the art. Other equations 54 are known and used for other purposes, such as strain energy from torque acting on a circular bar, strain energy on a beam subjected to a pure moment, strain energy in a beam due to shear stress, etc. Many other equations are known to those of skill in the art to determine stress, work, and other data for discrete elements 36 under various forces, such as torsion, and moment. These various equations are used in existing commercially available finite element analysis software, typically using partial differential equations, such as the software marketed under the trademark ANSA, which was developed by BETA CAE Systems S.A., and distributed in the United States by Beta CAE Systems, USA. Other examples include NASTRAN® by MSC, Genesis® by Vanderplaats R&D, Optistruct® by Altair Engineering, and many more.

Once the model 34 is developed, the equations 54 are solved by an iterative process that uses the results from the prior iteration, where the first iteration uses the baseline element value 52. In an exemplary embodiment, the first iteration of the finite element analysis begins by calculating 40 the element variable, using equation 1 above, where the baseline element value 52 is used for the mass fraction of each element 36. The results of the finite element analysis include the elasticity for the element 36. The elasticity is calculated 40 based on the load vector 24, the domain 22, required performance criterion 26, types of materials 28, and the mass fraction for the elements 36 using mathematical equations and formulas well known to those of skill in the art.

The stress, strain, or strain energy are also calculated 40 for each element 36 using equations 54 known to those of skill in the art. In an exemplary embodiment, the elements 36 are sorted and ranked according to the elasticity and strain energy, and predetermined statistical distribution functions assign a new iterative element variable 50, which is the mass fraction in an exemplary embodiment. The density ρ of the type of material 28 associated with the element 36 is multiplied by the volume of the element 36 to determine the mass, and the mass of all the elements 36 are added to obtain the total mass for the domain 22. In embodiments where the required performance criterion 26 includes a maximum allowable mass, the total mass is held at or below the maximum allowable mass. The new iterative element variable 50 is then used in the second iteration of the finite element analysis, again solving for equation 1, and the process is repeated until an endpoint is reached.

The mass fraction, (X), can vary between 0 and 1, where 0 represents a void element and 1 represents a full element, as mentioned above. Mathematically, the mass fraction value can be any value between 0 and 1, but the interpretation of the results are enhanced if the mass fraction value is forced to a value of 1 or 0, so the element 36 is represented as either full (for the associated type of material 28), or void. Therefore, the mathematical equations used to determine the new iterative element variable 50 are configured to gradually urge 42 the element variable 50 from the baseline element value 52 to a value representing either a full or void element 36, such as either 0 or 1 in one embodiment. Urging 42 the element variable 50 toward a value representing a full or void element 36 results in the element variable 50 being gradually forced to either a full or void value. The final result is a design topology 60 where each element 36 is represented as either full or void.

Equations 1 and 2 calculate 40 the mass fraction for a single type of material 28, so the equations only provide a full or void value for each element 36. The equations do not indicate if the element 36 should be one type of material 28 or another, and only indicate if the element 36 should be void or full of the one type of material 28 the element 36 is associated with. The properties of each type of material 28 are utilized in the calculations 40 for each element 36, so the plurality of types of materials 28 are jointly analyzed by evaluating the elements 36 associated with the different types of materials 28 during each iteration of the calculations 40. The density and elasticity for each element 36 are incorporated into the finite element analysis, so the properties of one type of material 28 influence the finite element analysis calculations 40 for a different type of material 28, because the density and elasticity in one element 36 influences the density and elasticity in other nearby elements 36. The strain energy (which is a function of elasticity) is used to calculate 40 the mass fraction for each element 36, so the final design topology 60 is influenced by the different properties of each type of material 28 simultaneously evaluated. Therefore, the strengths and weaknesses of each type of material 28, and the interaction of different types of materials 28, influence the final design topology 60. Simultaneous modeling of a plurality of types of materials 28 produces a finite element analysis that incorporates the interactions of different types of materials 28 unlike sequential modeling of a single type of material 28.

An end point is required for determining if the calculations are complete 44 and the final design topology 60 has been produced, so the iterative calculations 40 can be stopped. Different criteria can be used for determining if the calculations are complete 44 in different embodiments, and the criterion is determined based on the data entered for the problem constraint 20. In an exemplary embodiment, determining if the calculations are complete 44 is answered affirmatively when (1) every element 36 is represented by either a full or a void value, (2) the required performance criterion 26 is met, and (3) the objective function 30 is optimized. In an alternate embodiment where no objective function 30 is entered, the calculations are determined to be complete when (1) every element 36 is represented by either a full or a void value, and (2) the required performance criterion 26 is met. A secondary end point is assigned to prevent an infinite loop in some embodiments, where the finite element analysis will terminate after a predetermined number of iterations, or after a predetermined amount of computer time has lapsed.

The finite element analysis therefore includes, but is not limited to, (1) calculating 40 the element variable 50, (2) urging 42 the element variable 50 toward a full or a void value, and (3) determining if the calculations are complete 44. If the calculations are not complete, the process is repeated with another iteration. If the calculations are complete, the computer 10 uses the output device 18 to output the results. In one embodiment, the output includes the design topology 60 where the full elements 36 are displayed and the void elements 36 are not. The full elements 36 include an indication of the associated type of material 28, such as different colors or symbols for different types of materials 28.

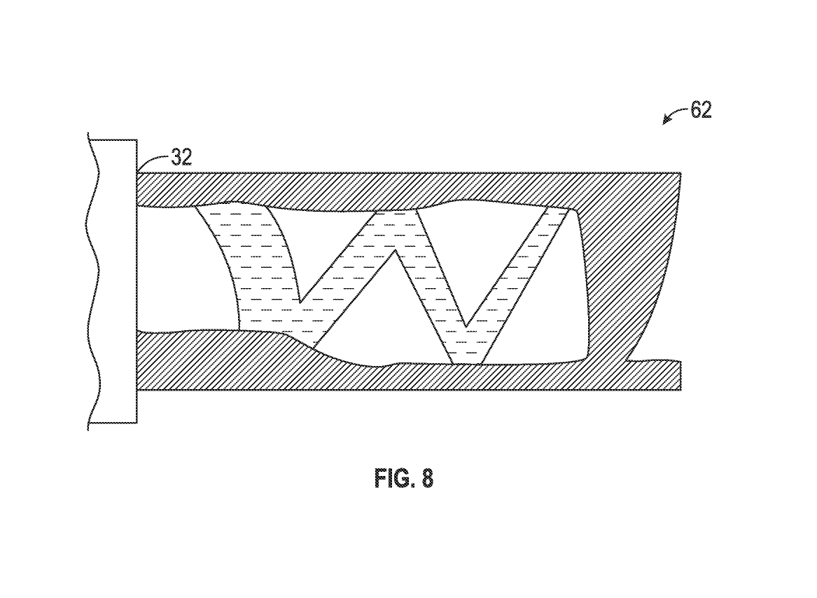

A hypothetical exemplary embodiment of a design topology 60 is illustrated in FIG. 7, where the hypothetical design topology 60 is based on the domain 22 and load vectors 24 illustrated in FIG. 5. The elements 36 associated with one type of material 28 are indicated with a dash, and those associated with the other type of material 28 are indicated by shading. As can be seen, the design topology 60 suggests certain areas should use the type of material represented by a dash, other areas should use the type of material represented by shading, and yet other areas can use either of the two types of materials. One potential structure 62 is illustrated in FIG. 8, where the structure 62 incorporates the basic shapes and material placement from the design topology 60 illustrated in FIG. 7. The structure 62 includes areas using the type of material represented by dashed horizontal lines, and areas using the type of material represented by shading.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of producing a design topology, the method comprising the steps of:
entering a problem constraint into a computer, wherein the problem constraint comprises a domain, a load vector, an objective function, and a plurality of types of materials;
dividing the domain into a plurality of elements, wherein individual elements are associated with one type of material such that each of the plurality of types of materials is associated with more than one element;
calculating a element variable for the elements;
determining if the calculations are complete, and if the calculations are not complete repeating calculating the element variable for the elements; and
outputting the design topology if the calculations are complete.

2. The method of claim 1 wherein the objective function comprises a minimum strain energy, and wherein determining if the calculations are complete further comprises determining if the element variable for the elements represents either a void value or a full value, and if the objective function of the minimum strain energy is optimized.

3. The method of claim 1 wherein:
entering the problem constraint further comprises entering a required performance criterion comprising a maximum allowable mass.

4. The method of claim 1 further comprising:
urging the element variable towards a void value or a full value after calculating the element variable.

5. The method of claim 1 wherein the domain comprises three dimensions, wherein each element comprises a element face, and wherein:
dividing the domain into the plurality of elements further comprises dividing the domain into the plurality of elements wherein the element face for each element abuts either a domain boundary or the element face for the element representing a different type of material.

6. The method of claim 1 wherein calculating the element variable further comprises calculating a mass fraction.

7. The method of claim 1 wherein entering the problem constraint further comprises entering three or more types of materials.

8. The method of claim 1 wherein dividing the domain into the plurality of elements further comprises associating every element with one of the types of materials.

9. The method of claim 1 wherein entering the problem constraint into the computer further comprises entering the problem constraint into a non-transitory computer readable medium of the computer.

10. A system for producing a design topology comprising:
a computer comprising a non-transitory computer readable media, an input device, and an output device, and wherein the computer is configured to:
accept entry from the input device of a problem constraint, wherein the problem constraint comprises a domain, a load vector, an objective function, and a plurality of types of materials;
divide the domain into a plurality of elements, wherein individual elements are associated with one type of material entered in the problem constraint such that each type of material is associated with more than one element;
iteratively calculate a element variable for the elements until the calculations are complete; and
output the design topology after the calculations are complete.

11. The system of claim 10 wherein the computer is further configured to determine if the calculations are complete by determining that the elements represents a void value or a full value, and the objective function is optimized.

12. The system of claim 11 wherein the objective function comprises a minimum strain energy.

13. The system of claim 10 wherein:
the problem constraint further comprises a required performance criterion, wherein the required performance criterion comprises a maximum allowable mass.

14. The system of claim 10 wherein the computer is further configured to assign a baseline value to the element variable for a first iteration of calculating the element variable, and wherein the baseline value is the same for every element associated with one of the plurality of types of materials.

15. The system of claim 10 wherein the computer is further configured to urge the element variable towards a void value or a full value after calculating the element variable.

16. The system of claim 10 wherein the domain comprises three dimensions, each element comprises a element face, and the element face for each element abuts either a domain boundary or the element face for the element associated with a different type of material.

17. The system of claim 10 wherein the plurality of types of materials comprises three or more types of materials.

18. The system of claim 10 wherein each element is assigned to one of the types of materials.

19. The system of claim 10 wherein the problem constraint further comprises assigning a portion of the domain to one of the types of materials.

20. A method of producing a design topology, the method comprising the steps of:
entering a problem constraint into a computer, wherein the problem constraint comprises a domain, a load vector, an objective function comprising minimum strain energy, a plurality of types of materials, and a required performance criterion comprising a maximum allowable mass;
dividing the domain into a plurality of elements, wherein each element is associated with one of the plurality of types of materials such that each of the plurality of types of materials is associated with more than one element;
calculating a element variable for each element with the computer, wherein the element variable is a mass fraction;
urging the element variable toward a full value or a void value;
determining if the calculations are complete by determining:
if the element variable for each element represent either the full value or the void value; and
if the objective function has been minimized;
returning to calculating the element variable for each element if the calculations are not complete; and
outputting the design topology if the calculations are complete.
